(19) United States
(12) Patent Application Publication
(10) Pub. No.: US 2005/0149483 A1
(43) Pub. Date: Jul. 7, 2005

(54) Optical recording medium, apparatus for recording/reproducing data on/from optical recording medium, and method of recording/reproducing data on/from optical recording medium

(75) Inventors: Sung-hee Hwang, Seoul (KR); Jung-wan Ko, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/023,575

(22) Filed: Dec. 29, 2004

(30) Foreign Application Priority Data
Jan. 5, 2004 (KR) 2004-369
Mar. 16, 2004 (KR) 2004-17662

(51) Int. Cl. G06F 7/00

(52) U.S. Cl. 707/1

(57) ABSTRACT

An information recording medium, an apparatus recording/reproducing data on/from the information recording medium, a method of recording/reproducing data on/from the information recording medium, and a computer-recordable recording medium storing a program executing the method of recording/reproducing data from the information recording medium. A lead-in area, a data area, and a lead-out area are arranged on the information recording medium. The lead-in area or the lead-out area includes a disc definition structure (DDS)/recording management data (RMD) zone for recording information on defect management and recording management. In the DDS/RMD zone a DDS used for defect management and a RMD are written. The data area includes a spare area (SA)/defect list (DL) zone for recording replacement data that replaces defective data on the information recording medium and information on defects that have occurred on the information recording medium. A DDS/RMD block includes data area allocation information and initialization information used for managing the information recording medium and is recorded in a first recordable portion of the DDS/RMD zone. The data area allocation information includes location information of a DDS/RMD zone arranged in the data area and location information of the SA/DL zone. Accordingly, it is possible to efficiently manage the storage capacity of a disc by effectively performing defect management on the disc.

### CROSS-REFERENCE TO RELATED APPLICATION

This application claims the benefit of Korean Patent Application Nos. 2004-369 and 2004-17662, filed on Jan. 5, 2004 and Mar. 16, 2004, respectively, in the Korean Intellectual Property Office, the disclosures of which are incorporated herein in their entirety by reference.

### BACKGROUND OF THE INVENTION

1. Field of the Invention

The present invention relates to a disc, and more particularly, to an information recording medium, an apparatus recording/reproducing data on/from the information recording medium, a method of recording/reproducing data on/from the information recording medium, and a computer-readable recording medium storing a program executing the method of recording/reproducing the data on/from the information recording medium.

2. Description of the Related Art

Defect management is a process for compensating for data loss caused by a defect in a user data area of a disc, i.e., a defective block, by rewriting user data recorded in the defective block to a new portion of the user data area. Generally, defect management is performed using a linear replacement method or a slipping replacement method. In the linear replacement method, a defective portion of a user data area is replaced with a non-defective portion of a spare area. In the slipping replacement method, a defective portion is slipped, and a next non-defective portion is used.

In the liner replacement method, a block of a user data area in which a defect occurs is called a defective block. A spare area composed of blocks, which are used as replacement blocks replacing defective blocks, is provided in a predetermined area of the disc. A lead-in area, a middle area, and a lead-out area are arranged on the disc according to manufacture specifications when manufacturing the disc, whereas allotment of the spare area on the disc is determined when initializing the disc before use.

In particular, data cannot be rewritten or overwritten on a write-once disc. Due to this characteristic of the write-once disc, it is required to efficiently manage the storage capacity of the write-once disc. In addition, it is also required to record disc management information somewhere on the write-once disc so that the disc management information can be easily found.

### SUMMARY OF THE INVENTION

According to an aspect of the present invention, there is provided an information recording medium, an apparatus for recording/reproducing data on/from the information recording medium and a method of recording/reproducing data on/from the information recording medium, which can help efficiently manage the storage capacity of the optical recording medium by effectively performing defect management and can help quickly find disc management information, and a computer-readable recording medium storing a program for executing the method.

According to an aspect of the present invention, there is provided an information recording medium, on which a lead-in area, a data area, and a lead-out area are arranged. Here, the lead-in area or the lead-out area includes a disc definition structure (DDS)/recording management data (RMD) zone for recording information on defect management and recording management information, in which a DDS used for defect management and a RMD are written. The data area includes a spare area (SA)/defect list (DL) zone for recording replacement data that replaces defective data on the information recording medium and defect information of defects that have occurred on the information recording medium, and a DDS/RMD block, which includes data area allocation information and initialization information used for managing the information recording medium. The DDS/RMD block is recorded in a first recordable portion of the DDS/RMD zone, and the data area allocation information includes location information of a DDS/RMD zone arranged in the data area and location information of the SA/DL zone arranged in the data area.

According to an aspect of the present invention, there is provided a defect list (DL) which contains containing initial defect information whose defect information number is set to “0” and which may be recorded in a first recordable portion of the SA/DL zone.

According to an aspect of the present invention, the DDS/RMD zone may be arranged in the data area when initializing the information recording medium.

According to an aspect of the present invention, the location information of the DDS/RMD zone arranged in the data area may be fixed.

According to an aspect of the present invention, the DDS/RMD zone may be arranged in the data area next to the SA/DL zone or in an ending portion of the data area.

According to an aspect of the present invention, if the DDS/RMD zone is arranged in the ending portion of the data area, a new SA/DL zone may be arranged in the data area ahead of the DDS/RMD zone.

According to another aspect of the present invention, there is provided an apparatus for recording/reproducing data on/from an information recording medium on which a lead-in area, a user data area, and a lead-out area are arranged. The apparatus includes: a writing/reading unit, which writes data on or reads data from the information recording medium; and a control unit, which controls the writing/reading unit so that the writing/reading unit writes a DDS used for defect management and recording management in a DDS/RMD zone arranged in the lead-in area or in the lead-out area, writes replacement data that replaces defective data on the information recording medium and defect information on defects that have occurred on the information recording medium in an SA/DL zone arranged in the data area, and writes a DDS/RMD block in a first recordable portion of the DDS/RMD zone. The DDS/RMD block includes data area allocation information and initialization information used for management of the information recording medium, and the data area allocation information includes location information of a DDS/RMD zone arranged in the data area and location information of the SA/DL zone.

According to an aspect of the present invention, the control unit may control the writing/reading unit to write a DL, containing initial defect information whose defect number information is set to “0”, in a first recordable portion of the SA/DL zone.

According to an aspect of the present invention, the control unit may arrange the DDS/RMD zone in the data area when initializing the information recording medium.

According to an aspect of the present invention, the control unit may fix the location information of the DDS/RMD zone arranged in the data area.

According to an aspect of the present invention, he control unit may arrange the DDS/RMD zone in the data area next to the SA/DL zone or in an ending portion of the data area.

According to an aspect of the present invention, ff the DDS/RMD zone is arranged in the ending portion of the data area, the control unit may arrange a new SA/DL zone in the data area ahead of the DDS/RMD zone.

According to another aspect of the present invention, there is provided a method of recording data on an information recording medium on which a lead-in area, a user data area, and a lead-out area are arranged. The method includes: writing a DDS used for defect management and recording management in a DDS/RMD zone arranged in the lead-in area or in the lead-out area; writing replacement data that replaces defective data on the information recording medium and information on defects that have occurred on the information recording medium in an SA/DL zone arranged in the data area; and writing a DDS/RMD block, which includes data area allocation information and initialization information used for management of the information recording medium, in a first recordable portion of the DDS/RMD zone, the data area allocation information including location information of a DDS/RMD zone arranged in the data area and location information of the SA/DL zone.

According to an aspect of the present invention, the method may also include writing a DL, which contains initial defect information whose defect information number is set to “0”, in a first recordable portion of the SA/DL zone.

According to an aspect of the present invention, the method may also include arranging the DDS/RMD zone in the data area when initializing the information recording medium.

According to an aspect of the present invention, the method may also include fixing the location information of the DDS/RMD zone arranged in the data area.

According to an aspect of the present invention, the method may also include arranging the DDS/RMD zone in the data area next to the SA/DL zone or in an ending portion of the data area.

According to an aspect of the present invention, the method may also include arranging a new SA/DL zone in the data area ahead of the DDS/RMD zone if the DDS/RMD zone is arranged in the ending portion of the data area.

According to another aspect of the present invention, there is provided a method of reproducing data from an information recording medium on which a lead-in area, a data area, and a lead-out area are arranged. The method includes: reading a DDS used for defect management and RMD used for recording management from a DDS/RMD zone arranged in the lead-in area or in the lead-out area; reading replacement data that replaces defective data on the information recording medium where defects have occurred and information on defects that have occurred on the information recording medium from an SA/DL zone arranged in the data area; reading a DDS/RMD block, which includes data area allocation information and initialization information used for management of the information recording medium, from a first recordable portion of the DDS/RMD zone, the data area allocation information including location information of a DDS/RMD zone arranged in the data area and location information of the SA/DL zone.

The method may include reading a DL, which contains containing initial defect information whose defect information number is set to “0”; from a first recordable portion of the SA/DL zone.

According to another aspect of the present invention, there is provided a computer-readable recording medium storing a program for executing a method of recording data on an information recording medium on which a lead-in area, a data area, and a lead-out area are defined. The method includes: writing a DDS used for defect management and recording management in a DDS/RMD zone arranged in the lead-in area or in the lead-out area; writing replacement data that replaces defective data on the information recording medium and information on defects that have occurred on the information recording medium in an SA/DL zone arranged in the data area; and writing a DDS/RMD block, which includes data area allocation information and initialization information used for management of the information recording medium, in a first recordable portion of the DDS/RMD zone, the data area allocation information including location information of a DDS/RMD zone arranged in the data area and location information of the SA/DL zone.

According to another aspect of the present invention, there is provided a computer-readable recording medium storing a program executing a method of reproducing data from an information recording medium on which a lead-in area, a data area, and a lead-out area are defined. The method includes: reading a DDS used for defect management and RMD used for recording management from a DDS/RMD zone arranged in the lead-in area or in the lead-out area; reading replacement data that replaces defective data on the information recording medium where defects have occurred and information on defects that have occurred on the information recording medium from an SA/DL zone arranged in the data area; and reading a DDS/RMD block, which includes data area allocation information and initialization information used for management of the information recording medium, from a first recordable portion of the DDS/RMD zone, the data area allocation information including location information of a DDS/RMD zone arranged in the data area and location information of the SA/DL zone.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of an apparatus recording/reproducing data on/from an optical recording medium, according to an embodiment of the present invention;

FIG. 2 is a diagram illustrating the structure of a single recording layered disc according to an embodiment of the present invention;

FIG. 3 is a diagram illustrating the structure of a single recording layered disc according to another embodiment of the present invention;

FIG. 4 is a diagram illustrating the structure of a spare area/defect list (SA/DL) zone according to an embodiment of the present invention;

FIG. 5 is a diagram illustrating the structure of DL #i of FIG. 4;

FIG. 6 is a diagram illustrating the structure of ‘information on defect #i’ of FIG. 5;

FIG. 7 is a diagram illustrating a method of recording defect management information on defects that have occurred in a user area in an SA/DL zone according to an embodiment of the present invention;

FIG. 8 is a diagram illustrating the structure of a disc definition structure/recording management data (DDS/RMD) zone according to an embodiment of the present invention;

FIG. 9A is a diagram illustrating the structure of a disc according to another embodiment of the present invention, in which an SA/DL zone has been arranged in a data area at the stage of initializing the disc;

FIG. 9B is a diagram illustrating the structure of an example of a disc according to another embodiment of the present invention, in which an SA/DL zone and a DDS/RMD zone have been arranged in a data area at the stage of initializing the disc;

FIG. 9C is a diagram illustrating the structure of another example of the disc of FIG. 9B;

FIG. 9D is a diagram illustrating the structure of another example of the disc of FIG. 9B;

FIG. 9E is a diagram illustrating the structure of another example of the disc of FIG. 9B;

FIG. 9F is a diagram illustrating the structure of another example of the disc of FIG. 9B;

FIG. 10A is a diagram illustrating the structure of DDS/RMD #0 according to an embodiment of the present invention;

FIG. 10B is a diagram illustrating the structure of DL #0 according to an embodiment of the present invention;

FIG. 11A is a diagram illustrating the structure of DDS/RMD #0 according to another embodiment of the present invention;

FIG. 11B is a diagram illustrating the structure of DL #0 according to another embodiment of the present invention;

FIG. 12 is a flowchart of a method of initializing an optical disc according to an embodiment of the present invention; and

FIG. 13 is a flowchart of a method of recording/reproducing data on/from an optical disc according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

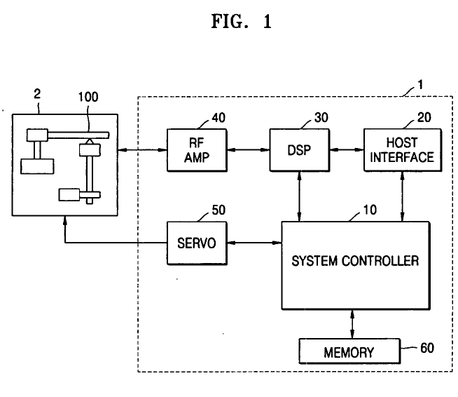

FIG. 1 is a block diagram of an apparatus recording/reproducing data on/from an optical recording medium according to an embodiment of the present invention. Referring to FIG. 1, the apparatus includes a writing/reading unit 2 and a control unit 1.

The writing/reading unit 2 includes a pickup and writes data on or reads data from a disc 100, which is an example of an optical recording medium according to an aspect of the present invention.

The control unit 1 controls the writing/reading unit 2 to write data on or read data from the disc 100 by following a predetermined file system. In one embodiment of the present invention, the control unit 1 adopts a verify-after-write method, in which it is determined whether there are defective portions on the disc 100 by recording data on the disc 100 on a predetermined data unit basis and then verifying the data. In each recording operation, the control unit 1 writes data on the disc 100 and determines which portions on the disc 100 are defective. Thereafter, the control unit 1 generates defect information indicating which portions on the disc 100 are defective, stores the defect information in a memory (not shown), and records a portion of defect information stored in the memory on the disc 100 as temporary defect information.

A recording operation is determined based on a user's command and which type of data recording the user desires to perform and ranges from the moment the disc 100 is loaded in the apparatus to the moment the disc 100 is unloaded from the apparatus after recording data on the disc 100. In each recording operation, a process of verifying data written on the disc 100 is performed at least one time, typically, more than two times. The temporary defect information, obtained as a result of performing the verify-after-write method, is temporarily stored in the memory.

When a user hits an ‘eject’ button on the apparatus after completing the recording of data on the disc 100 and then removes the disc 100 from the apparatus, the control unit 1 recognizes that a current recording operation has ended. Then, the control unit 1 reads the temporary defect information from the memory, provides the temporary defect information to the writing/reading unit 2, and commands the writing/reading unit 2 to record the temporary defect information on the disc 100.

The control unit 1 includes a system controller 10, a host interface 20, a digital signal processor 30, a radio frequency (RF) amplifier 40, a servo 50, and a memory 60.

When recording data on the disc 100, the host interface 20 receives a write command from a host (not shown) and transmits the write command to the system controller 10. The system controller 10 controls the digital signal processor 30 and the servo 50 in order to execute the write command received from the host interface 20. The digital signal processor 30 adds additional data, such as parity data, to data to be recorded, received from the host interface 20, generates error correction code (ECC) blocks by ECC encoding the addition results, and modulates the ECC blocks in a predetermined manner. The RF amplifier 40 converts data output from the digital signal processor 30 into an RF signal. The writing/reading unit 2 records the RF signal received from the RF amplifier 40 on the disc 100. The servo 50 receives a command required for servo control from the system controller 10 and servo-controls the pickup of the writing/reading unit 2.

For efficient disc and defect management, the system controller 10 operates as follows. Given that the disc 100 includes a lead-in area, a data area, and a lead-out area, the system controller 10 controls the writing/reading unit 2 so that the writing/reading unit 2 writes defect management information and recording management information in a DDS/RMD zone provided in the lead-in or lead-out area of the disc 100, writes replacement data replacing data stored in defective blocks of the disc 100 and information on the defective blocks in an SA/DL zone provided in the data area, and writes a DDS/RMD block in a first recordable portion of the DDS/RMD zone. Here, the DDS/RMD block contains data area allocation information, which includes location information of the DDS/RMD zone and location information of the SA/DL zone, and initialization information used for disc management.

In addition, the system controller 10 controls the writing/reading unit 2 so that the writing/reading unit 2 writes a defect list (DL), containing initial defect information whose defect information number is set to “0” in a first recordable portion of the SA/DL zone.

Moreover, the system controller 10 arranges the DDS/RMD zone in the data area when initializing the disc 100 and fixes the location of the DDS/RMD zone so that the location information of the DDS/RMD zone never changes. Specifically, the system controller 10 may arrange the DDS/RMD zone right next to the SA/DL zone, which is located in a beginning portion of the data area, or may arrange the DDS/RMD zone in an ending portion of the data area. In a case where the system controller 10 arranges the DDS/RMD zone in an ending portion of the data area, a new SA/DL zone is arranged ahead of the DDS/RMD zone.

When reproducing data from the disc 100, the host interface 20 receives a read command from the host (not shown). The system controller 10 performs an initialization process required for reproducing data from the disc 100. The writing/reading unit 2 applies a laser beam to the disc 100, obtains an optical signal by receiving a laser beam reflected from the surface of the disc 100, and outputs the optical signal. The RF amplifier 40 converts the optical signal output from the writing/reading unit 2 into an RF signal, obtains modulated data and a servo signal from the RF signal, and provides the modulated data and the servo signal to the digital signal processor 30 and the servo 50, respectively. Here, the servo signal is used for controlling the servo 50. The digital signal processor 30 demodulates the modulated data received from the RF amplifier 40 and performs error correction on the demodulation results, thereby obtaining ECC data. The servo 50 receives the servo signal from the RF amplifier 40 and receives a command required for servo control from the system controller 10. Then, the servo 50 performs servo control on the pickup of the writing/reading unit 2 using the servo signal and the command. The host interface 20 receives the ECC data from the digital signal processor 30 and then transmits the ECC data to the host (not shown). The system controller 10 controls the servo 50 so that the servo 50 can read disc management information or disc defect information from the disc 100 and can read data from non-defective portions of the disc 100 based on the disc management information or disc defect information.

Given that the disc 100 includes the lead-in area, the data area, and the lead-out area, the system controller 10 controls the writing/reading unit 2 so that the writing/reading unit 2 reads the defect management information and the recording management information from the DDS/RMD zone provided in the lead-in or lead-out area of the disc 100, reads the replacement data replacing the data stored in the defective blocks of the disc 100 and the information on the defective blocks from the SA/DL zone provided in the data area, and reads the DDS/RMD block from the first recordable portion of the DDS/RMD zone. As described above, the DDS/RMD block contains the data area allocation information, which includes the location information of the DDS/RMD zone and the location information of the SA/DL zone, and the disc initialization information for disc management.

In addition, the system controller 10 controls the writing/reading unit 2 so that the writing/reading unit 2 reads the DL, containing the initial defect information whose defect information number is set to “0”, from the first recordable portion of the SA/DL zone.

The apparatus of FIG. 1 may be separated into an apparatus for recording data on an optical recording medium and an apparatus for reproducing data from an optical recording medium.

The structure of an optical recording medium according to an embodiment of the present invention will be described in the following in greater detail.

Disc management information (DMI), which is recorded on the optical recording medium according to the embodiment of the present invention, includes a DDS, RMD, and a DL. A disc management area (DMA), in which DMI is recorded, includes a temporary disc management area (TDMA), in which temporary DMI is recorded, and a finalized disc management area (FDMA), in which finalized DMI is recorded.

A TDMA includes a DDS/RMD zone, in which a DDS and RMD are recorded, and a DL zone, in which a DL is recorded.

A DDS includes location information of a TDMA or location information of DMI. Specifically, a DDS includes location information of an SA/DL zone, in which replacement blocks are located and a DL is recorded, location information of a DDS/RMD zone, location information of the DL in the SA/DL zone, location information of each recordable portion of the SA/DL zone, in which an updated DL or replacement data can be stored, a consistency flag, which is used for determining whether a disc has been normally ejected from the apparatus during a previous recording operation, and record protection information, which is used for preventing data from being recorded on the disc.

RMD, which is used for managing data recorded on a disc, includes R-zone entries, which specify the states of the respective R-zones in a sequential recording mode, or a bitmap, which is a map of bit values respectively indicating whether data is recorded in the respective recording blocks of a user data area in a random recording mode.

A DDS/RMD zone, in which the DDS and the RMD are recorded, is provided in a lead-in or lead-out area of a single-layered recording disc or in a lead-in, middle, or lead-out area of a double-layered recording disc. At the stage of initializing a disc before using the disc, a drive manufacturer or a user may define part of a user data area of the disc as the DDS/RMD zone, thereby increasing the number of times each DDS/RMD block can be updated.

A DL includes location information of defective blocks, which are detected during recording/reproducing data on/from a disc, and location information of replacement blocks, which respectively replace the defective blocks. A DL zone, in which the DL is recorded, is not a fixed zone. Rather, the DL zone is arranged in an SA/DL in a user data area of the disc whenever a request for updating the DL is issued. Conventionally, a spare area is provided at a predetermined portion of a disc, wherein replacement blocks are located. In the SA/DL zone, which is a counterpart of the spare area in the prior art, replacement blocks are located, and the DL, which includes disc defect information, i.e., location information of defective blocks of a disc and location information of replacement blocks, is recorded.

A disc is finalized when no recording space is left on the disc so that data cannot be recorded on the disc any longer or when a user does not want to record data on the disc any longer or wants to use the disc only for data reproduction purposes. Disc management information on the finalized disc is stored in an FDMA on the finalized disc.

A power calibration area (PCA) is provided on the disc for determining which one of a plurality of recording powers that have been used when recording data on the disc is an optimal recording power and determining variables associated with a write strategy that has been used when recording the data on the disc.

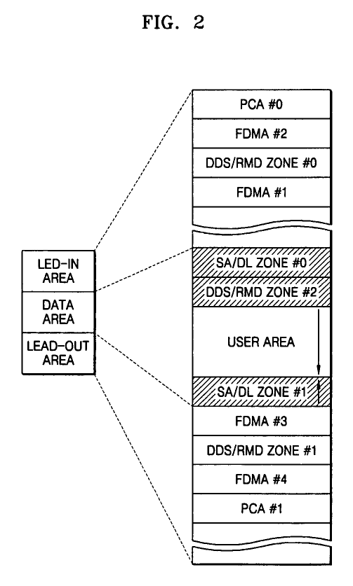

FIG. 2 is a diagram illustrating the structure of a single-layered recording disc according to an embodiment of the present invention. Referring to FIG. 2, a lead-out area is formed along the outer circumference of the single-layered recording disc, a lead-in area is formed along the inner circumference of the single-layered recording disc, and a user data area is interposed between the lead-out area and the lead-in area.

The lead-in area includes PCA #0, FDMA #1, FDMA #2, and DDS/RMD zone #0, the user data area includes a user data area, SA/DL zone #0, SA/DL zone #1, DDS/RMD zone #2, and the lead-out area includes PCA #1, FDMA #3, FDMA #4, and DDS/RMD zone #1.

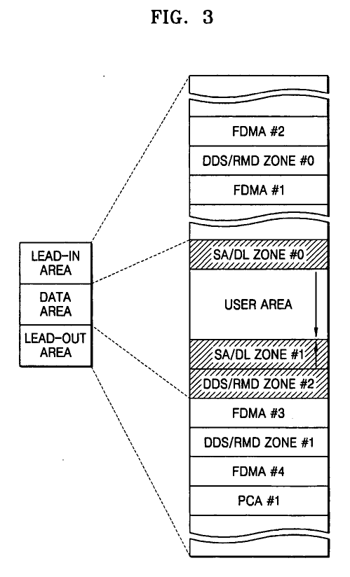

FIG. 3 is a diagram illustrating the structure of a single-layered recording disc according to another embodiment of the present invention. Referring to FIG. 3, a lead-out area is formed along the outer circumference of the single-layered recording disc, a lead-in area is formed along the inner circumference of the single-layered recording disc, and a user data area is interposed between the lead-out area and the lead-in area.

The lead-in area includes FDMA #1, FDMA #2, and DDS/RMD zone #0, the user data area includes a user data area, SA/DL zone #0, SA/DL zone #1 and DDS/RMD Zone#2, and the lead-out area includes a PCA#1, FDMA #3, FDMA #4 and DDS/RMD Zone#1.

A temporary disc management area (i.e., an SA/DL zone) provided on the disc of each of FIGS. 2A through 3D will now be described in greater detail.

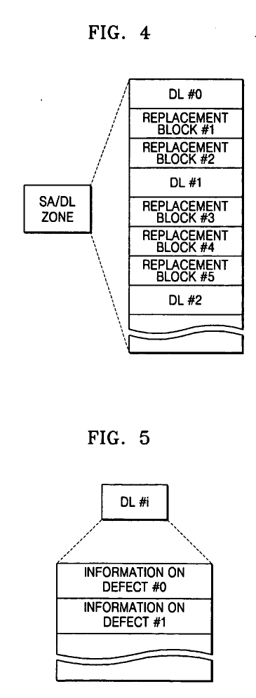

Referring to FIG. 4, an SA/DL zone is provided on a disc as part of a user data area, regardless of whether the disc is a single-layered recording disc or a double-layered recording disc.

As described above, the SA/DL zone includes replacement blocks, which respectively replace defective blocks in the user data area, and stores disc defect information, which includes location information of the defective blocks in the user data area and location information of the replacement blocks. When there is a need to replace a defective block with a replacement block due to a defect occurring in a user data area, location information of the defective block and location information of the replacement block should be recorded somewhere in the user data area so that a disc drive can search for the replacement block and can fetch data from the searched replacement block, rather than from the defective block, when a host issues a command to read data from the defective block.

Since replacement blocks are closely related to a DL, the DL is preferably, but not necessarily, updated whenever a replacement block is newly assigned to each defective block in the user data area. Preferably, but not necessarily, the replacement blocks and the DL are located in the same zone, rather than in different areas. Specifically, the replacement blocks are provided in a recordable portion of a predetermined area, and then the DL is recorded in another recordable portion of the predetermined area. Accordingly, a pickup does not need to move back and forth between two different areas providing the replacement blocks in one of the areas and recording the DL in the other area. Therefore, it is possible to reduce the time required for a seek operation and to efficiently use the storage capacity of a disc.

When manufacturing a disc, predetermined portions of the disc are designated as a lead-in area, a middle area, and a lead-out area according to predetermined manufacture standards. However, an SA/DL zone is defined on the disc when initializing the disc because it is hard to determine how much of an area on the disc is required for replacement blocks and a DL until using the disc. Therefore, in order to prepare an area on the disc for the replacement blocks and the DL, SA/DL zone #0 is defined on the disc according to the predetermined manufacturing standards at the stage of manufacturing the disc, and, if necessary, SA/DL zone #1 may be defined in an end portion of a user data area on the disc at the stage of initializing the disc according to a disc manufacturer or user's intent. When defining SA/DL zone #1 on the disc, a direction in which data is recorded in SA/DL zone #1 is preferably, but not necessarily, set to be opposite to a direction in which data is recorded in a user data area on the disc, thereby facilitating the expansion of the user data area in the data recording direction of the user data area. Accordingly, it is possible to efficiently use the storage capacity of the disc.

A DDS/RMD zone is provided in a lead-in area or lead-out area on a single-layered recording disc or in a lead-in, middle, or lead-out area on a double-layered recording disc.

As described above, a DDS includes location information of a TDMA or location information of DMI, and RMD may be R-zone state information in a sequential recording mode, in which data is sequentially recorded in a user data area, or may be data recording state information indicating whether data is recorded on each of a plurality of recording blocks in the user data area in a random recording mode, in which data is arbitrarily recorded in the user data area.

FIG. 4 is a diagram illustrating the structure of an SA/DL zone according to an embodiment of the present invention. Referring to FIG. 4, the SA/DL zone includes DL #0, replacement block #1, replacement block #2, DL#1, replacement block #3, replacement block #4, replacement block #5, and DL #2.

DL #0 may include initialization information. In recording operation #0, defects #1 and #2 occur. Then, replacement blocks #1 and #2, which respectively replace defective blocks #1 and #2, respectively corresponding to defects #1 and #2, are arranged in a recordable portion of the SA/DL zone next to a recordable portion of the SA/DL zone occupied by DL #0. Thereafter, DL #1, including information on defects #1 and #2, is recorded in a recordable portion of the SA/DL zone next to the recordable portion occupied by replacement blocks #1 and #2. In recording operation #1, defects #3, #4, and #5 occur. Then, replacement blocks #3, #4, and #5, which respectively replace defective blocks #3, #4, and #5, respectively corresponding to defects #3, #4, and #5, are arranged in a recordable portion of the SA/DL zone next to the recordable portion occupied by DL #1. Thereafter, DL #2, including information on defects #3, #4, and #5, is recorded in a recordable portion of the SA/DL zone next to the recordable portion occupied by replacement blocks #3, #4, and #5.

While defects #1, #2, #3, #4, and #5 are illustrated in FIG. 4 as if the present invention were restricted to defects that have occurred during recording operations, the present invention can also be applied to defects that have occurred during reproducing operations.

As described above, when defects occur, replacement blocks are arranged in one recordable portion of the SA/DL zone, and then a DL, including information on the defects, is recorded in another recordable portion of the SA/DL zone next to the recordable portion of the SA/DL zone occupied by the replacement blocks.

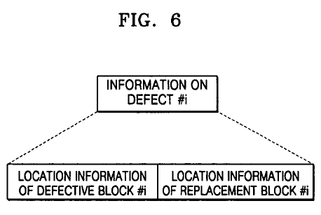

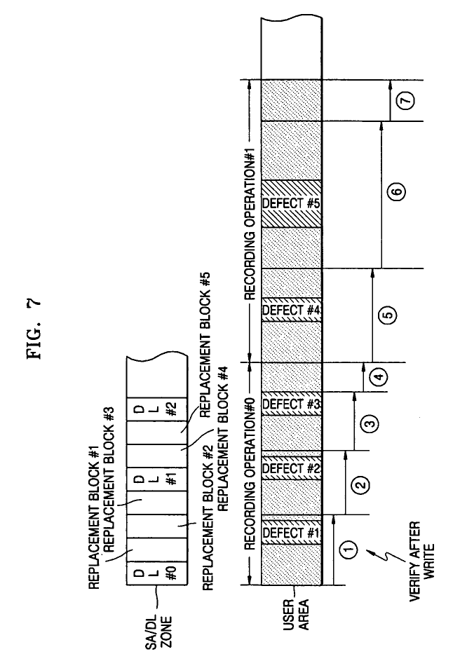

FIG. 5 is a diagram illustrating the structure of DL #i of FIG. 4. Referring to FIG. 5, DL #i includes information on at least one defect, i.e., information on defects #0 and #1. Information on one defect corresponds to information on one defective block and one replacement block replacing the defective block. Information on defect #i is illustrated in FIG. 6.

FIG. 6 is a diagram illustrating the information on defect #i. Referring to FIG. 6, the information on defect #i includes location information of defective block #i and location information of replacement block #i. For example, the location information of defective block #i may be a sector serial number of defective block #i, and the location information of replacement block #i may also be a sector serial number of replacement block #i. The information on defect #i may further include predetermined state information (not shown).

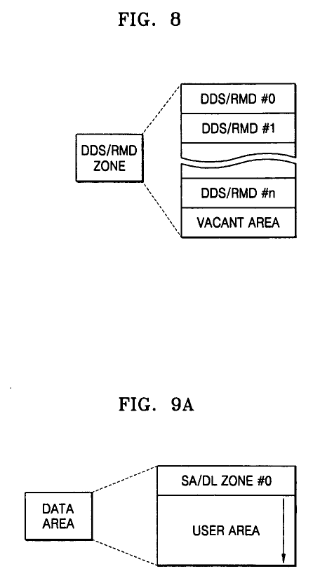

FIG. 7 is a diagram illustrating a method of recording information on defects that have occurred in a user data area on a disc in an SA/DL zone according to an embodiment of the present invention. Data can be processed on a sector-by-sector basis or on a cluster-by-cluster basis. A sector is a minimal unit area that can be managed by a file system or an application program of a computer, and a cluster is a minimal unit area, on which data can be recorded on a disc at one time. In general, one or more sectors constitute one cluster.

A sector is divided into a physical sector or a logical sector. A physical sector is a space in which data is recorded. An address called physical sector number (PSN) is allotted to each physical sector. A logical sector is a unit, based on which a file system or application program of a computer manages data, and an address called logical sector number (LSN) is allotted to each logical sector. An apparatus searches for an area on a disc where data is to be recorded by referencing the PSN of the data. The file system or application program manages data recorded on the disc on a logic sector-by-logic sector basis and also manages the location of the data by referencing the LSN of the data.

Referring to FIG. 7, a plurality of physical sectors (not shown), to which PSNs are respectively allotted, exist in a user data area and in the SA/DL zone. LSNs are respectively allotted to consecutive groups of the physical sectors, each including at least one physical sector. The LSNs are not allotted to defective sectors in the user data area. Thus, even if a physical sector has the same size as a logical sector, the number of PSNs may not be identical to the number of LSNs any longer, once defects occur on a disc.

Referring to FIG. 7, reference numerals \mathring{1} through \mathring{7} denote units in each of which data is written and verified. An apparatus for recording/reproducing data on/from an optical recording medium records user data in the area \mathring{1} and then returns to the beginning of the area \mathring{1} to verify whether the user data has been successfully recorded in the area \mathring{1} or whether a defect has occurred in the area \mathring{1}. If the apparatus detects defect #1 in the area \mathring{1}, it defines a portion of the area \mathring{1} where defect #1 has occurred as defective block #1 and records part of the user data that has been recorded in defective block #1 in a portion of the SA/DL zone. The portion of the SA/DL zone, which replaces defective block #1 by storing part of the user data that has been recorded in defective block #1, is defined as replacement block #1. Thereafter, the apparatus records user data in the area \mathring{2} and then returns to the beginning of the area \mathring{2} to verify whether the user data has been successfully recorded in the area \mathring{1} or whether a defect has occurred in the area \mathring{2}. If the apparatus detects defect #2 in the area \mathring{2}, it defines a portion of the area \mathring{2} where defect #2 has occurred as defective block #2 and records part of the user data that has been recorded in defective block #2 in a portion of the SA/DL zone. The portion of the SA/DL zone, which replaces defective block #2 by storing part of the user data that has been recorded in defective block #2, is defined as replacement block #2. Likewise, a portion of the area \mathring{3} where defect #3 occurs is defined as defective block #3, and a portion of the SA/DL zone where user data that has been recorded in defective block #3 is recorded is defined as replacement block #3. Since no defect occurs in the area \mathring{4}, no portion of the area \mathring{4} is defined as a defective block.

If recording operation #0, in which the user data is recorded and then verified in each of the areas \mathring{1} through \mathring{4}, is expected to end soon (e.g., if a user hits an ‘eject’ button or all of the user data allotted for recording operation #0 has been recorded), the apparatus records DL #1 including information on defects #1, #2, and #3, in the SA/DL zone.

When recording operation #1 begins, user data is recorded in each of the areas \mathring{5} through \mathring{7}, defects #4 and #5 are detected in the areas \mathring{5} and \mathring{6}, respectively, portions of the SA/DL zone are defined as replacement blocks #4 and #5 for respectively replacing portions of the areas \mathring{5} and \mathring{6} where defects #4 and #5 are detected. Thereafter, if recording operation #1 is expected to end soon, DL #2, containing information on defects #4 and #5, is recorded in the SA/DL zone.

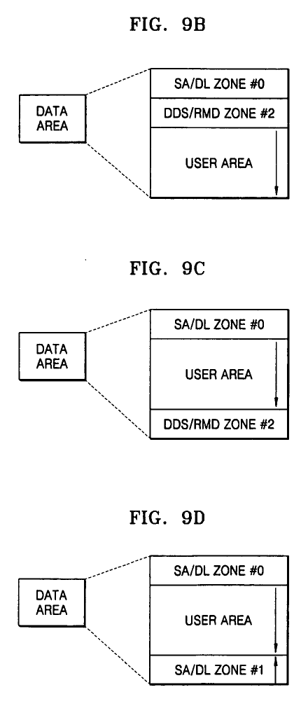

FIG. 8 is a diagram illustrating the structure of a DDS/RMD zone according to an embodiment of the present invention. Referring to FIG. 8, the DDS/RMD zone includes DDS/RMD #0, DDS/RMD #1, . . . , DDS/RMD #n and a vacant area.

DDS/RMD #0 contains initialization information. Each of DDS/RMD #1, . . . , and DDS/RMD #n contains location information of DMI, and RMD. The location information of the DMI and the RMD may change whenever a disc is used. Therefore, whenever the location information of the DMI and the RMD changes, corresponding DDS/RMD is updated. DDS/RMD #1 through #n are sequentially recorded side by side in the DDS/RMD area.

In a case where a plurality of DDS/RMD areas exist on a disc, the DDS/RMD areas are preferably, but not necessarily, used one after another. In other words, only after one DDS/RMD area is used up, another DDS/RMD area subsequent to the DDS/RMD area can be used. If the disc is a single-layered recording disc, DDS/RMD areas located in the vicinity of the inner circumference of the disc are used ahead of DDS/RMD areas located in the vicinity of the outer circumference of the disc. If the disc is a double-layered recording disc, of those DDS/RMD areas located in the vicinity of the inner circumference of the disc, DDS/RMD areas on a first recording layer are used ahead of DDS/RMD areas on a second recording layer. Therefore, the DMD/RMD areas on the disc are used in the order of DDS/RMD area #0, DDS/RMD area #1, DDS/RMD area #2, and DDS/RMD area #3. Accordingly, when the disc is loaded in a disc drive, it is possible to easily identify and then access one of the DDS/RMD areas on the disc where a DDS and RMD have been most recently recorded by determining, in advance, in which order the DDS/RMD areas are to be used.

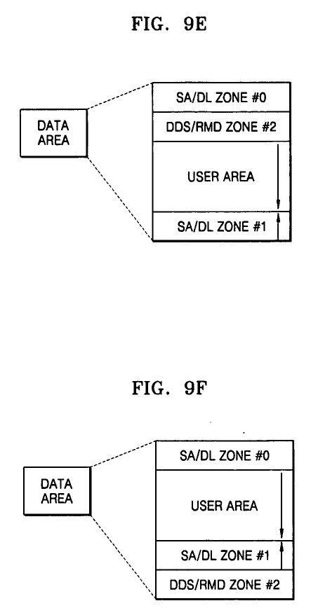

FIG. 9A is a diagram illustrating the structure of a disc according to an embodiment of the present invention, in which an SA/DL zone has been arranged in a data area at the stage of initializing the disc. Referring to FIG. 9A, SA/DL zone #0 is arranged in a beginning porting of the data area of the disc, and the rest of the data area is used as a user area. A direction of use of the user area, i.e., a direction in which user data is recorded in the user area, is marked by an arrow in FIG. 9A.

FIG. 9B is a diagram illustrating the structure of an example of a disc according to another embodiment of the present invention, in which an SA/DL zone and a DDS/RMD zone have been arranged in a data area at the stage of initializing the disc.

Referring to FIG. 9B, SA/DL zone #0 is arranged in a beginning portion of the data area, and DDS/RMD zone #2 is arranged next to SA/DL zone #0. The user area except for the portions occupied by SA/DL zone #0 and DDS/RMD zone #2 is used as a user area. If DDS/RMD zone #0 and DDS/RMD zone #1 have already been arranged in a lead-in area and a lead-out area, respectively, of the disc in the process of manufacturing the disc, as shown in FIGS. 2 and 3, DDS/RMD zone #2 is arranged in the data area at the stage of initializing the disc.

FIG. 9C is a diagram illustrating another example of the disc of FIG. 9B. Referring to FIG. 9C, SA/DL zone #0 is arranged in a beginning portion of a data area, and DDS/RMD zone #2 is arranged in an ending portion of the data area. The data area except for the portions occupied by SA/DL zone #0 and DDS/RMD zone #2 is used as a user area.

FIG. 9D is a diagram illustrating another example of the disc of FIG. 9B. Referring to FIG. 9D, SA/DL zone #0 is arranged in a beginning portion of a data area, and SA/DL zone #1 is arranged in an ending portion of the data area. The data area except for the portions occupied by SA/DL zone #0 and SA/DL zone #1 is used as a user area. If the direction of use of the user area is from the beginning portion to the ending portion of the data area, the direction of use of SA/DL zone #1 is preferably, but not necessarily, set to be opposite to the direction of use of the user area in terms of facilitating the expansion or reduction of SA/DL zone #1 is facilitated.

FIG. 9E is a diagram illustrating the structure of another example of the disc of FIG. 9B. Referring to FIG. 9E, SA/DL zone #0 and SA/DL zone #1 are arranged in a beginning portion and an ending portion, respectively, of a data area, and DDS/RMD zone #2 is arranged next to SA/DL zone #0. The data area except for the portions occupied by SA/DL zone #0, DDS/RMD zone #2, and SA/DL zone #1 is used as a user area. As described above with reference to FIG. 9D, the direction of use of SA/DL zone #1 is preferably, but not necessarily, set to be opposite to the direction of use of the user area in terms of facilitating the expansion or reduction of SA/DL zone #1.

FIG. 9F is a diagram illustrating the structure of another example of the disc of FIG. 9B. Referring to FIG. 9F, SA/DL zone #0 and DDS/RMD zone #2 are arranged in a beginning portion and an ending portion, respectively, of a data area, and SA/DL zone #1 is arranged next to DDS/RMD zone #2. The data area except for the portions occupied by SA/DL zone #0, SA/DL zone #1, and DDS/RMD zone #2 is used as a user area. As described above with reference to FIG. 9D, the direction of use of SA/DL zone #1 is preferably, but not necessarily, set to be opposite to the direction of use of the user area in terms of facilitating the expansion or reduction of SA/DL zone #1.

Even though SA/DL zone #1 was not arranged on a disc at the stage of initializing the disc, as shown in FIGS. 9A through 9C, SA/DL zone #1 may be arranged on the disc during disc use, if necessary, for example, if SA/DL zone #0 is used up. If no zone has been arranged in an ending portion of a data area of the disc at the state of initializing the disc, as shown in FIGS. 9A and 9B, SA/DL zone #1 may be arranged in the ending portion of the data area, as shown in FIGS. 9D and 9E. If DDS/RMD zone #2 was arranged in the ending portion of the data area at the stage of initializing the disc, as shown in FIG. 9C, SA/DL zone #1 may be arranged ahead of DDS/RMD zone #2 so that the direction of use of SA/DL zone #1 is opposite to the direction of use of a user area.

In the present invention, once a DDS/RMD zone is arranged in a data area of a disc when initializing the disc, the DDS/RMD zone is prevented from expanding afterwards, and allocation of new DDS/RMD zones to the data area is prohibited because DDS/RMD blocks in the DDS/RMD zone contain pointers indicating the location of DMI and recording management information and the location information of the DDS/RMD zone. In other words, when the disc is loaded in a disc drive, the disc drive should obtain a final DDS/RMD block from the disc in order to obtain final DMI. Thereafter, the disc drive obtains location information of a DL from the final DDS/RMD block and then searches for the DL with reference to the location information of the DL. Thereafter, the disc drive obtains pointers from the DDS/RMD zone and searches for various information designated by the pointers. However, if the DDS/RMD zone is expanded during the use of the disc or if a new DDS/RMD zone is arranged in the data area during the use of the disc, the existing location information of the DDS/RMD zone is not valid any longer, in which case, the disc drive cannot determine the exact location of the DDS/RMD zone in the data area when the disc is loaded therein. Thus, it takes the disc drive a considerable amount of time to search for the final DDS/RMD block. In order to solve this problem, the DDS/RMD zone is arranged in the data area only at the stage of initializing the disc, and DDS/RMD #0 and DL #0, which are initialization information, are preferably, but not necessarily, recorded in a beginning portion of the DDS/RMD zone and a beginning portion of an SA/DL zone, respectively. In other words, as shown in FIGS. 2 and 3, DDS/RMD #0 is recorded in a first recordable portion of DDS/RMD zone #0, and DL #0 is recorded in a first recordable portion of SA/DL zone #0 arranged in the beginning portion of the data area. Accordingly, a drive system can easily obtain the initialization information from the disc.

Information stored in DDS/RMD #0 and DL#0 will be described in the following in greater detail.

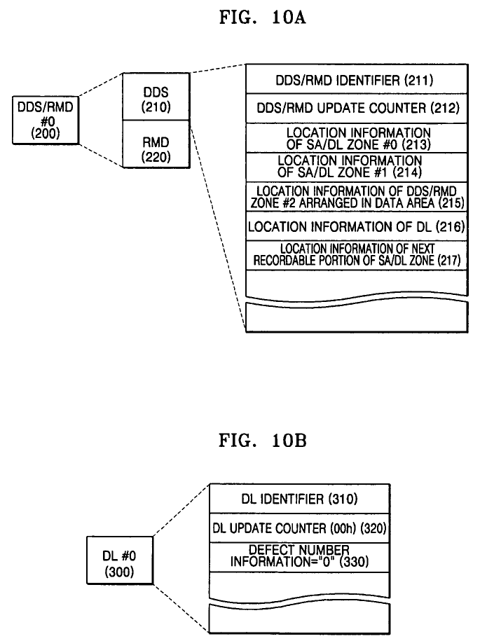

FIG. 10A is a diagram illustrating the structure of DDS/RMD #0 according to an embodiment of the present invention. Referring to FIG. 10A, DDS/RMD #0 (200) includes a DDS 210 and RMD 220.

The DDS 210 includes a DDS/RMD identifier 211, a DDS/RMD update counter (00 h) 212, location information 213 of SA/DL zone #0, location information 214 of SA/DL zone #1, location information 215 of DDS/RMD zone #2, location information 216 of a DL, and location information 217 of a next recordable portion of an SA/DL zone.

The DDS/RMD identifier 211 indicates that DDS/RMD #0 is a DDS/RMD block. The DDS/RMD update counter 212 indicates how many times DDS/RMD #0 has been updated. Since DDS/RMD #0 is a first DDS/RMD block in the DDS/RMD zone, the DDS/RMD update counter 212 is set to 00 h. The location information 213 of SA/DL zone #0 specifies where in a data area SA/DL zone #0 is located. The location information 214 of SA/DL zone #1 specifies where in the data area SA/DL zone #1 is located. The location information 213 of SA/DL zone #0 or the location information 214 of SA/DL zone #1 may include addresses of beginning and ending portions of SA/DL zone #0 or SA/DL zone #1, the address of the beginning portion of SA/DL zone #0 or SA/DL zone #1 and the size of SA/DL zone #0 or SA/DL zone #1, or the address of the ending portion of SA/DL zone #0 or SA/DL zone #1 and the size of SA/DL zone #0 or SA/DL zone #1. The location information 215 of DDS/RMD zone #2 specifies where in the DDS/RMD zone DDS/RMD zone #2 is located. The location information 216 of the DL specifies where in the SA/DL zone the DL is recorded. The location information 217 of the next recordable portion of the SA/DL zone helps easily find the next recordable portion of the SA/DL zone when there is a need to record a replacement block or a DL in the SA/DL zone.

FIG. 10B is a diagram illustrating the structure of DL #0 according to an embodiment of the present invention. Referring to FIG. 10B, DL #0 (300) includes a DL identifier 310, a DL update counter 320, and defect number information 330.

The DL identifier 310 indicates which DL #0 contains a DL. The DL update counter 320 indicates the number of times the DL has been updated. Since DL #0 is a first DL, the DL update counter 320 is set to 00 h. The defect number information 330 specifies how many defect list entries DL #0 includes. Since DL #0 only contains initialization information, the defect number information 330 is set to “0”.

As described above, DDS/RMD #0 of FIG. 10A and DL #0 of FIG. 10B constitute DMI of an initialized disc. DDS/RMD #0 and DL #0 are recorded in a first recordable portion of a DDS/RMD zone and a first recordable portion of a SA/DL zone, respectively. Then, when the initialized disc is loaded in a disc drive, the disc drive can easily obtain initialization information from the initialized disc by accessing the DDS/RMD zone and the SA/DL zone.

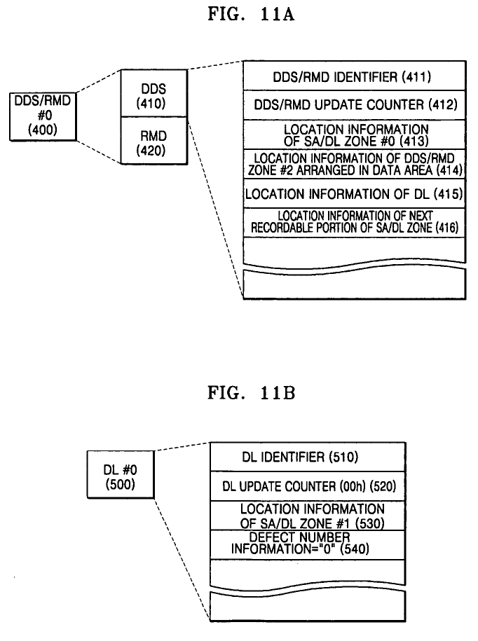

FIG. 11A is a diagram illustrating the structure of DDS/RMD #0 according to another embodiment of the present invention. Referring to FIG. 11A, DDS/RMD #0 (400) includes a DDS 410 and an RMD 420.

The DDS 410 includes a DDS/RMD identifier 411, a DDS/RMD update counter (00 h) 412, location information 413 of SA/DL zone #0, location information 414 of DDS/RMD zone #2, location information 415 of a DL, and location information 416 of a next recordable portion of an SA/DL zone.

FIG. 11B is a diagram illustrating the structure of DL#0 according to another embodiment of the present invention. Referring to FIG. 11B, DL #0 (500) includes a DL identifier 510, a DL update counter 520, location information 530 of SA/DL zone #1, and defect number information 540.

The present embodiment is the same as the previous embodiment except that the location information 530 of SA/DL zone #1 is included in DL #0, rather than in DDS/RMD #0.

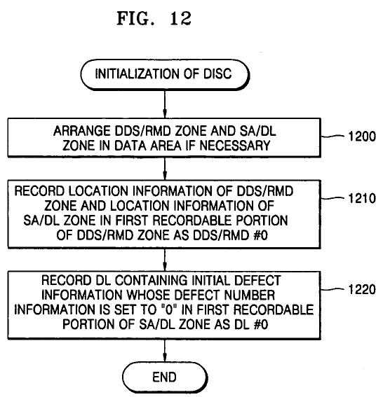

FIG. 12 is a flowchart of a method of initializing an optical disc according to an embodiment of the present invention. Referring to FIG. 12, in operation 1200, a system controller 10 of a drive system allots a DDS/RMD zone and an SA/DL zone in a data area of a disc at the stage of initializing the disc. The DDS/RMD zone and the SA/DL zone may be arranged in a beginning portion and/or an ending portion of the data area, as described above with reference to FIGS. 9A through 9F.

In operation 1210, the system controller 10 records location information of the DDS/RMD zone and location information of the SA/DL zone in a first recordable portion of the DDS/RMD zone as DDS/RMD #0. In other words, the system controller 10 controls a writing/reading unit 2 to form DDS/RMD #0 having the structure of FIG. 10A or 11A and to record DDS/RMD #0 in the first recordable portion of the DDS/RMD zone.

In operation 1220, the system controller 10 records a DL containing initial defect information whose defect information number is set to “0” in a first recordable portion of the SA/DL zone as DL #0. In other words, the system controller 10 controls the writing/reading unit 2 to form DL #0 having the structure of FIG. 10B or 11B and to record DL #0 in the first recordable portion of the SA/DL zone.

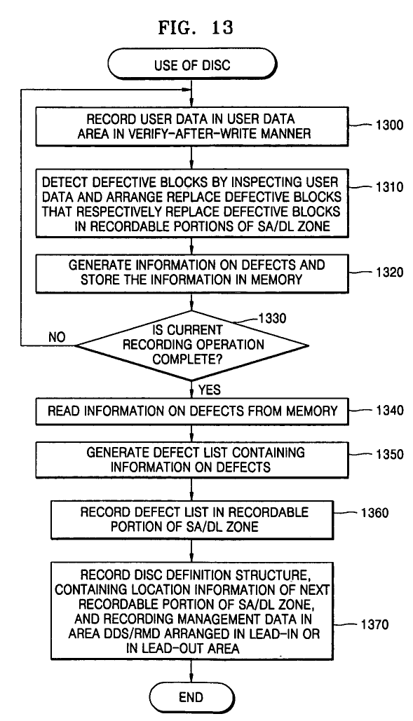

FIG. 13 is a flowchart of a method of recording/reproducing data on/from an optical disc according to an embodiment of the present invention. Referring to FIG. 13, in operation 1300, an apparatus recording data on an optical disc records user data in a data area on a disc in a write-after-verify manner. In operation 1310, defective blocks are detected in the data area by inspecting the data recorded in operation 1300 for defects, and replacement blocks respectively replacing the defective blocks are provided in an SA/DL zone, which is arranged in the data area. In operation 1310, a controller of the apparatus designates portions of the SA/DL zone that are yet to be used as the replacement blocks.

In operation 1320, information on defects, i.e., location information of the defective blocks and location information of the replacement blocks, is generated and then stored in a memory. Operations 1300 through 1320 are repeated until a current recording operation is expected to end.

If the current recording operation is expected to end in operation 1330 after the recording of the user data in the user data area is complete, the controller of the apparatus reads the information of defects from the memory in operation 1340.

In operation 1350, a DL, including information on at least one defect, is generated. In operation 1360, the DL is recorded in a portion of the SA/DL zone next to a portion of the SA/DL zone that has been most recently allotted for a replacement block.

In operation 1370, a DDS, including a portion of the SA/DL zone where data can be recorded next and RMD are recorded in a DDS/RMD area, which occupies part of a lead-in area or lead-out area.

The present invention can be applied not only to a write-once recording medium but also to a rewritable recording medium.

The method of recording/reproducing data on/from an optical recording medium according to an aspect of the present invention may be configured as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for configuring the processing methods can be easily construed by programmers skilled in the art to which the present invention pertains.

As described above, according to an aspect of the present invention, it is possible to efficiently manage the storage capacity of a disc by effectively managing defects on the disc.

Although a few embodiments of the present invention have been shown and described, it will be understood by those of ordinary skill in the art that various changes in form and details may be made therein without departing from the spirit and scope of the present invention as defined by the following claims.

1. An information recording medium, on which a lead-in area, a data area, and a lead-out area are arranged,
wherein the lead-in area or the lead-out area comprises a disc definition structure (DDS)/recording management data (RMD) zone for recording information on defect management and recording management, in which a DDS used for the defect management and an RMD are written,
the data area comprises a spare area (SA)/defect list (DL) zone for recording replacement data that replaces defective data on the information recording medium and information on defects that have occurred on the information recording medium, and a DDS/RMD block, which comprises data area allocation information and initialization information used for managing the information recording medium, is recorded in a first recordable portion of the DDS/RMD zone, the data area allocation information comprising location information of a DDS/RMD zone, and location information of the SA/DL zone arranged in the data area.

2. The information recording medium of claim 1, wherein a defect list (DL) containing initial defect information whose defect information number is set to “0” is recorded in a first recordable portion of the SA/DL zone.

3. The information recording medium of claim 2, wherein the DDS/RMD zone is arranged in the data area when initializing the information recording medium.

4. The information recording medium of claim 1, wherein the location information of the DDS/RMD zone arranged in the data area is fixed.

5. The information recording medium of claim 1, wherein the DDS/RMD zone is arranged in the data area next to the SA/DL zone or is arranged in an ending portion of the data area.

6. The information recording medium of claim 5, wherein, if the DDS/RMD zone is arranged in the ending portion of the data area, a new SA/DL zone is arranged in the data area ahead of the DDS/RMD zone.

7. An apparatus recording/reproducing data on/from an information recording medium on which a lead-in area, a user data area, and a lead-out area are arranged, the apparatus comprising:
a writing/reading unit, which writes data on or reads data from the information recording medium; and
a control unit, which controls the writing/reading unit so that the writing/reading unit writes a Disc Definition Structure (DDS) used for defect management and recording management in a DDS/Recording Management Data (RMD) zone arranged in the lead-in area or in the lead-out area, writes replacement data that replaces defective data on the information recording medium and defect information on defects that have occurred on the information recording medium in an Spare Area (SA)/Defect List (DL) zone arranged in the data area, and writes a DDS/RMD block, which comprises data area allocation information and initialization information used for management of the information recording medium, in a first recordable portion of the DDS/RMD zone, the data area allocation information comprising location information of the DDS/RMD zone and location information of the SA/DL zone, arranged in the data area.

8. The apparatus of claim 7, wherein the control unit controls the writing/reading unit to write a DL, containing initial defect information whose defect number information is set to “0”, in a first recordable portion of the SA/DL zone.

9. The apparatus of claim 8, wherein the control unit arranges the DDS/RMD zone in the data area when initializing the information recording medium.

10. The apparatus of claim 7, wherein the control unit fixes the location information of the DDS/RMD zone arranged in the data area.

11. The apparatus of claim 7, wherein the control unit arranges the DDS/RMD zone in the data area next to the SA/DL zone or arranges the DDS/RMD zone in an ending portion of the data area.

12. The apparatus of claim 11, wherein, if the DDS/RMD zone is arranged in the ending portion of the data area, the control unit arranges a new SA/DL zone in the data area ahead of the DDS/RMD zone.

13. A method of recording data on an information recording medium on which a lead-in area, a user data area, and a lead-out area are arranged, the method comprising:
writing a Disc Definition Structure (DDS) used for defect management and recording management in a DDS/Recording management Data (RMD) zone arranged in the lead-in area or in the lead-out area;
writing replacement data that replaces defective data on the information recording medium and defect information on defects that have occurred on the information recording medium in an SA/DL zone arranged in the data area; and
writing a DDS/RMD block, which comprises data area allocation information and initialization information used for management of the information recording medium, in a first recordable portion of the DDS/RMD zone, the data area allocation information comprising location information of the DDS/RMD zone and location information of the SA/DL zone, arranged in the data area.

14. The method of claim 13 further comprising:
writing a DL, containing initial defect information whose defect information number is set to “0”, in a first recordable portion of the SA/DL zone.

15. The method of claim 14 further comprising:
arranging the DDS/RMD zone in the data area when initializing the information recording medium.

16. The method of claim 13 further comprising:
fixing the location information of the DDS/RMD zone arranged in the data area.

17. The method of claim 13 further comprising:
arranging the DDS/RMD zone in the data area next to the SA/DL zone or in an ending portion of the data area.

18. The method of claim 17 further comprising:
arranging a new SA/DL zone in the data area ahead of the DDS/RMD zone if the DDS/RMD zone is arranged in the ending portion of the data area.

19. A method of reproducing data from an information recording medium on which a lead-in area, a data area, and a lead-out area are arranged, the method comprising:
reading a Disc Definition Structure (DDS) used for defect management and a Recording Management Data (RMD) used for recording management from a DDS/RMD zone arranged in the lead-in area or in the lead-out area;
reading replacement data that replaces defective data on the information recording medium where defects have occurred and reading information on the defects that have occurred on the information recording medium from an SA/DL zone arranged in the data area; and
reading a DDS/RMD block, which comprises data area allocation information and initialization information used for management of the information recording medium, from a first recordable portion of the DDS/RMD zone, the data area allocation information comprising location information of the DDS/RMD zone and location information of the SA/DL zone, arranged in the data area.

20. The method of claim 19 further comprising:
reading a DL, containing initial defect information whose defect information number is set to “0”, from a first recordable portion of the SA/DL zone.

21. A computer-readable recording medium storing a program executing a method of recording data on an information recording medium on which a lead-in area, a data area, and a lead-out area are defined, the method comprising:
writing a DDS used for defect management and recording management in a DDS/RMD zone arranged in the lead-in area or in the lead-out area;
writing replacement data that replaces defective data on the information recording medium and information on defects that have occurred on the information recording medium in an SA/DL zone arranged in the data area; and
writing a DDS/RMD block, which comprises data area allocation information and initialization information used for management of the information recording medium, in a first recordable portion of the DDS/RMD zone, the data area allocation information comprising location information of the DDS/RMD zone and location information of the SA/DL zone, arranged in the data area.

22. A computer-readable recording medium storing a program executing a method of reproducing data from an information recording medium on which a lead-in area, a data area, and a lead-out area are defined, the method comprising:
reading a Disc Definition Structure (DDS) used for defect management and a Recording Management Data (RMD) used for recording management from a DDS/RMD zone arranged in the lead-in area or in the lead-out area;
reading replacement data that replaces defective data on the information recording medium where defects have occurred and reading information on the defects that have occurred on the information recording medium from an SA/DL zone arranged in the data area; and
reading a DDS/RMD block, which comprises data area allocation information and initialization information used for management of the information recording medium, from a first recordable portion of the DDS/RMD zone, the data area allocation information comprising location information of the DDS/RMD zone and location information of the SA/DL zone arranged in the data area.

23. An information recording medium, including a lead-in area, a data area, and a lead-out area, wherein the data area comprises:
a Spare Area (SA)/Defect List (DL) zone for recording replacement data that replaces defective data on the information recording medium and for recording defect information of the defective data; and
a Disc Definition Structure (DDS)/Recording Management Data (RMD) zone comprising data area allocation information and initialization information used for managing the information recording medium, wherein the data area allocation information comprises location information of the DDS/RMD zone and the SA/DL zone in the data area.

24. The information recording medium of claim 23, wherein the DDS/RMD zone includes Disc Definition Structure (DDS) and Recording Management Data RMD).

25. The information recording medium of claim 24, wherein the Disc Definition Structure includes location information of the SA/DL zone, location information of the DDS/RMD zone, location information of the Defect List in the SA/DL zone, location information of recordable portions of the SA/DL zone, a consistency flag, and record protection information.

26. The information recording medium of claim 24, wherein the Recording Management Data includes R-zone entries, which specify states of respective R-zones in a sequential ordering mode, or a bitmap of values indicating whether data is recorded in recording blocks of a user data area in a random recording mode.

27. The information recording medium of claim 23, wherein the DDS/RMD zone is provided in the lead-in or lead-out area of a single-layered recording disc or in a lead-in, middle, or lead-out area of a double-layered recording disc.

28. The information recording medium of claim 23, wherein the DL zone includes a Defect List.

29. The information recording medium of claim 28, wherein the Defect List includes location information of defective blocks detected during recording/reproducing of data on/from the information recording medium, and location information of replacement blocks, which replace the defective blocks.
